(19) United States
(12) Patent Application Publication
(10) Pub. No.: US 2008/0090610 A1
(43) Pub. Date: Apr. 17, 2008

(54) Portable electronic device

(75) Inventors: Hsiu-Wen Wang, Jhubel City (TW); Chao-Chung Chang, Jhonghe City (TW)

Correspondence Address: Tung & Associates;Suite 120, 838 W. Long Lake Road, Bloomfield Hills, MI, 48302, US

(73) Assignee: Alpha Imaging Technology, R.O.C.

(21) Appl. No.: 11/581,116

(22) Filed: Oct. 13, 2006

(51) Int. Cl. H04M 1/00

(52) U.S. Cl. 455/556.2

(57) ABSTRACT

The present invention discloses a portable electronic device which includes: a memory module, an integrated chip, and an output module. The integrated chip includes a demodulator, an error correction module, a plurality of decoders, and an image processing module, which are capable of sharing the memory module and respectively performing a demodulating operation, an error correction operation, a decoding operation, and an image processing operation; the processed image signals and audio signals are transmitted to and outputted by the output device.

### BACKGROUND OF THE INVENTION

1. Field of the Invention

The present invention relates to a portable electronic device, in particular to a portable electronic device which includes a demodulation module and a multi-media module integrated in one integrated circuit.

2. Description of the Related Art

Technology improvements have caused portable electronic devices (such as mobile phones) to be more and more powerful, capable of providing many functions and applications. For example, nowadays many kinds of mobile phones support multi-media functions so that a user may view multi-media information via the display screen of a mobile phone.

FIG. 1 shows a block diagram of a conventional mobile phone 100. As seen in FIG. 1, to process multi-media information, the conventional mobile phone 100 includes a tuner 111, a stand-alone demodulation chip 110 and a stand-alone multi-media processor chip 120. The tuner 111 receives and processes external RF (radio frequency) signals. The demodulation chip 110 demodulates the signals outputted from the tuner 111, and transmits the demodulated signals to the multi-media processor chip 120 for further processing. The multi-media processor chip 120 receives the signals outputted from the demodulation chip 110 and decodes them to generate display signals. Thereafter, a display device 130 may output the display signals so that a user may view multi-media information from the display device 130.

More specifically, referring to FIG. 1, the demodulation chip 110 includes an OFDM (orthogonal frequency-division multiplexing) demodulator 112, a processor 113, a memory 114, an error correction module 115, and an ADC (analog-to-digital converter) 116. The tuner 111 receives RF signals and decreases the frequency of the signals. The ADC 116 converts the analog signals outputted from the tuner 111 to digital signals. The OFDM demodulator 112 demodulates the digital signals to generate multi-media signals (such as multi-media signals which comply with MPEG format or H264 format). The processor 113, memory 114 and error correction module 115 cooperate to correct possible errors in the multi-media signals (for example, the processor 113 may execute a firmware stored in the error correction module 115 to thereby perform error correction by means of the memory 114). The corrected signals are transmitted to the multi-media processor chip 120 via SPI (serial peripheral interface) 117.

The multi-media processor chip 120 includes a decoder 121, a memory 122, a processor 123, an LCD (liquid crystal display) controller 124, and an image processing module 125. The decoder 121 may be an MPEG decoder or an H264 decoder. The decoder 121 may cooperate with the memory 122 to decode signals transmitted from the demodulation chip 110, and generate image signals (such as RGB signals) that may be displayed on the display device 130. The LCD controller 124 controls the image signals so that they are displayed on the display device 130.

In addition, the processor 123, the memory 122 and the image processing module 125 may be used to support other image processing operations. As an example, the processor 123 may, in cooperation with the memory 122, execute a firmware related to the image processing module 125, to process the abovementioned image signals for generating images or audio effects, and transmits the processed image signals to the LCD controller 124, for further display.

The functions and operations of the abovementioned components are well-known to those skilled in this art, and therefore the details thereof are omitted. There are other components in the mobile phone 100 for supporting communication, such as the baseband circuit, which is also omitted because it is well-known to those skilled in this art.

It should be noted that the demodulation chip 110 and the multi-media processor chip 120 are often provided by different chip providers, and each is assembled in the mobile phone 100 in the form of a stand-alone integrated circuit chip. However, such arrangement results in many restrictions limitations to the hardware and software architecture.

For example, if the received signals are television signals (such as signals in compliance with DVB-T specification), the demodulation chip 110 may have to pick up a user-required program by the processor 113, but the picked-up program needs to be temporarily stored in the memory 114 of the demodulation chip 110. Thus, if the number of the picked-up programs or if the program itself is large, the capacity of the memory 114 of the demodulation chip 110 should be correspondingly increased. However, it is not cost-effective to build in a large memory 114 in the demodulation chip 110.

In addition, the demodulation chip 110 needs to perform error correction, but a complete error correction block consumes a large memory capacity. When the demodulation chip 110 is performing error correction, it generally has to store a complete error correction block in the memory 114, and performs error correction decoding (such as Reed-Solomon decoding) on the error correction block. When storing the error correction block, data are continuously stored in continuous addresses in the memory along one dimension (row by row, for example), but during the following decoding (such as Reed-Solomon decoding), data are read along the other dimension (by column, for example). Thus, during reading data, the memory has to repeatedly switch between rows, which consumes huge bandwidth of the memory. If the memory 114 is made of a DRAM (Dynamic Random Access Memory), the situation is worse. If the memory 114 is made of an SRAM (Static Random Access Memory), due to chip size constraint, the capacity of the memory is limited. Therefore, due to cost and other concerns, there has not yet been proposed a highly efficient error correction method for use in the demodulation chip 110.

### SUMMARY OF THE INVENTION

Therefore, a primary objective of the present invention is to provide a portable electronic device including a demodulation module and a multi-media module integrated in one integrated circuit, to solve the issue in the prior art.

According to a preferred embodiment the present invention, a portable electronic device is disclosed which comprises:

an integrated chip, including: a memory module; an ADC (analog-to-digital converter) for converting an analog input signal to a digital input signal; a demodulator coupled to said memory module for demodulating said digital input signal to generate a demodulated signal, and storing said demodulated signal in said memory module; an error correction module coupled to said memory module for performing error correction on said demodulated signal in said memory module to generate a multi-media signal; a video decoder coupled to said memory module for receiving said multi-media signal and, in cooperation with said memory module, performing a video decoding operation on said multi-media signal to generate an image signal; an audio decoder for receiving said multi-media signal and, in cooperation with said memory module, performing an audio decoding operation on said multi-media signal to generate an audio signal; a graphic data decoder coupled to said memory module for receiving said multi-media signal and, in cooperation with said memory module, performing a graphic data decoding operation on said multi-media signal to generate a graphic data; and an image processing module coupled to said memory module, and in cooperation with said memory module, for processing said decoded graphic data or image signal to generate a display signal; and

an output module coupled to said integrated chip for generating said display signal or said audio signal.

The many modules in the mobile phone according to the present invention are integrated in one integrated chip, so that the modules can share one memory module or even one processor, to reduce cost and save area of the integrated chip. In addition, because the capacity and bandwidth of the memory module according to the present invention are better than that of the dedicated memory built in the demodulation module in the prior art, many operations are more efficient due to the use of a better memory module. Further, the present invention also proposes an error correction method to maximize the error correction efficiency.

### BRIEF DESCRIPTION OF THE DRAWINGS

FIG. 1 is a block diagram showing a conventional mobile phone.

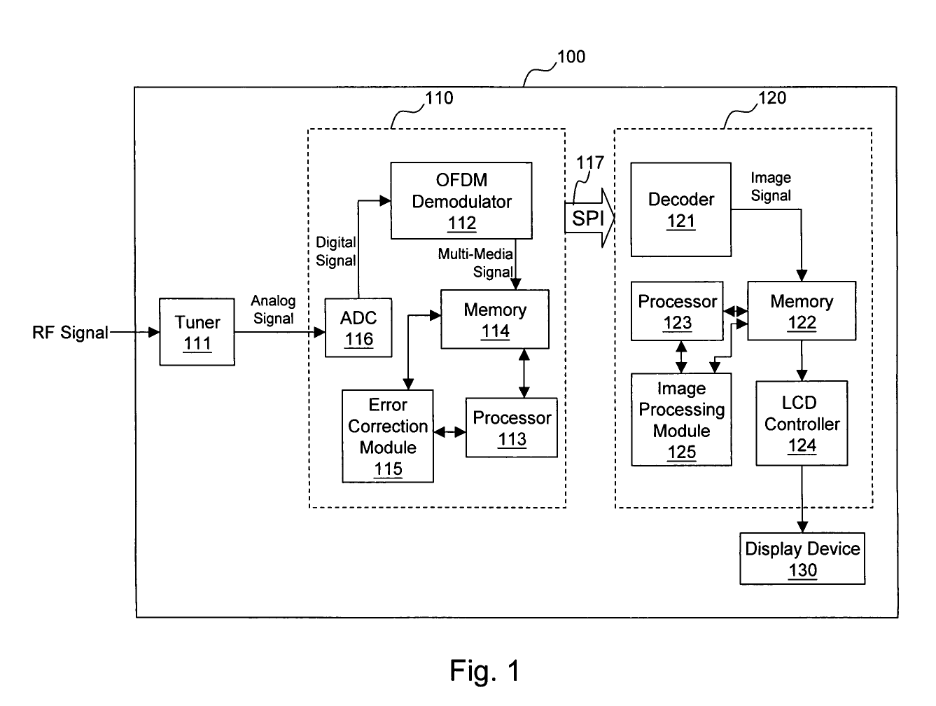

FIG. 2 is a block diagram showing a preferred embodiment of a mobile phone according to the present invention.

FIG. 3 schematically shows how error correction is preformed according to a preferred embodiment of the present invention.

### DESCRIPTION OF THE PREFERRED EMBODIMENT

The present invention will be described below in detail by illustrative embodiments with reference to the attached drawings.

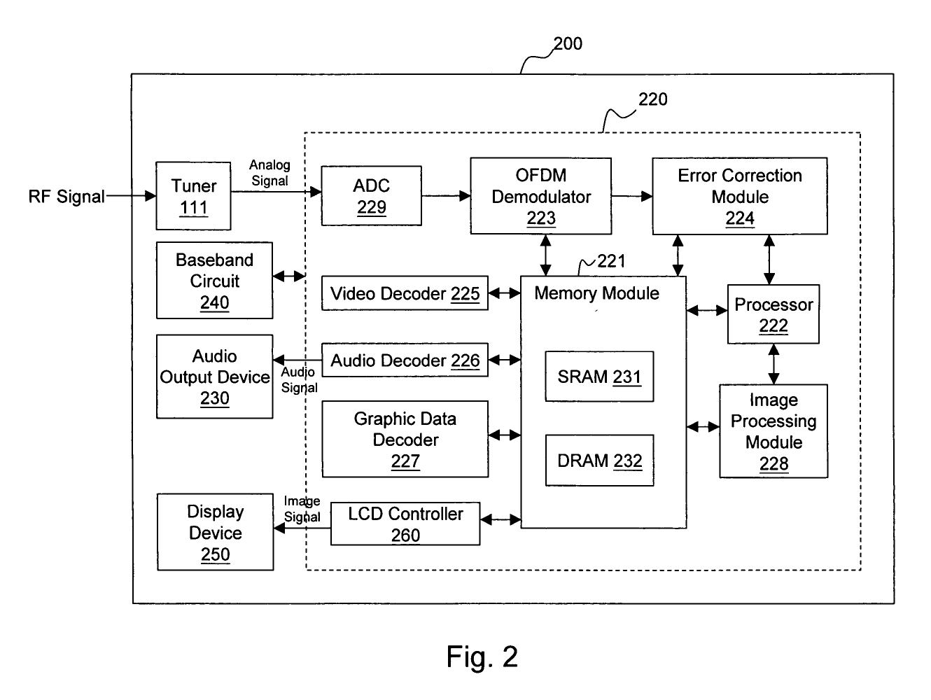

Referring to FIG. 2 which schematically shows a preferred embodiment of a mobile phone 200 according to the present invention, which comprises a tuner 211, an integrated chip 220, an audio output device 230 (such as a speaker), a baseband circuit 240, and a display device 250 (such as an LCD screen). The integrated chip 220 includes a memory module 221, a processor 222, an ODFM demodulator 223, an error correction module 224, a video decoder 225, an audio decoder 226, a graphic data decoder 227, an image processing module 228, an ADC 229, and an LCD controller 260. The chip integration may be done by manufacturing all the aforementioned devices of the integrated chip 220 on one semiconductor substrate, as well know by those skilled in this art. The memory module 221 preferably includes an SRAM module 231 and a DRAM module 232, to cooperate with the devices of the integrated chip 220.

It should be noted that, because the mobile phone 200 according to the present invention includes one integrated chip, the demodulation operation and the multi-media processing operation do not each require an individual stand-alone memory or processor. The mobile phone 200 may use the same memory module 221 and processor 222 for either the demodulation operation or the multi-media processing operation.

In addition, due to the integration, the memory module 221 in the mobile phone 200 has a larger capacity, and the processor 222 has a better performance; thus, for the demodulation operation and the error correction operation, the hardware constraint is less because the operation may be executed by a memory module 221 having a larger capacity and the processor 222 having a better performance, and the overall efficiency is better.

Moreover, because the demodulation chip and the multi-media chip in the prior art have been integrated into one chip, the serial peripheral interface in the prior art is no longer necessary; for example, the communication among devices may be achieved through a parallel peripheral interface, or through a bus architecture. As a more specific example, after the error correction module 224 and the processor 222 complete error correction, the error corrected multi-media signal may be directly transmitted to one or more of the video decoder 225, audio decoder 226, and graphic data decoder 227 for decoding, or, the corrected multi-media signal may be stored in the memory module 221, so that when one of the video decoder 225, audio decoder 226 and graphic data decoder 227 is required to performing decoding operation, it may retrieve data from the memory module 221 for such operation. Thus, the devices in the integrated chip 220 may communicate with one another more efficiently, and a designer is more flexible in designing the circuit.

The other devices in the mobile phone 200, such as the baseband circuit 240, may cooperate with the processor 222 to support the communication function of the mobile phone, as well known by those skilled in this art. It should be noted that the abovementioned mobile phone 200 is only for illustration rather than limitation of the present invention; it may include other devices not shown, such as a flash memory as a storage medium, and the integrated chip 220 may include a corresponding communication interface with the flash memory. All such variations should belong to the scope of the present invention.

The operation of the integrated chip 220 will be explained in detail below.

The tuner 211 performs a similar function as that of the tuner 111; that is, the tuner 211 is for receiving an external RF signal and decreasing the frequency of the signal to generate an analog signal.

Next, the ADC 229 converts the analog signal to a digital signal. The OFDM demodulator 223 performs demodulation (such as OFDM demodulation operation) on the digital signal to generate a multi-media signal (such as a multi-media signal complying with MPEG format or H264 format). The error correction module 224 cooperates with the processor 222 for performing error correction. The error correction module 224 does not necessarily have to be a hardware circuit, but instead may be a firmware executable by the processor 222 for error correction operation. Thus, when a multi-media signal is generated by the OFDM demodulator 223, the shared processor 22 may execute the firmware in the error correction module 224, to perform error correction in cooperation with the memory module 221, and transmit the corrected signal to a decoder at a following stage (such as one or more of the video decoder 225, audio decoder 226, and graphic data decoder 227; these decoders are shown in the diagram for illustration, but actually they do not necessarily have to be a hardware circuit, but instead may be a software program). As mentioned above, there is no limitation to the communication among the devices in the integrated chip 220 according to the present invention; the corrected signal may be transmitted through a serial peripheral interface, a parallel peripheral interface, or a bus architecture.

Next, the video decoder 225/audio decoder 226/graphic data decoder 227 decodes the multi-media signal transmitted thereto. As several examples, the video decoder 225 may include an MPEG decoder or an H264 decoder capable of decoding video data in the multi-media signal which complies with the MPEG format or the H264 format. The audio decoder 226 may decode the audio part in the multi-media signal. The graphic data decoder 227 may be, for example, a JPEG decoder capable of decoding graphic data in compliance with the JPEG format.

It should be noted that these decoders may use the memory module 221 to decode the multi-media signal transmitted from the OFDM demodulator 223. For example, according to MPEG specification, the decoding of an image frame may require reference to a previous or a next image frame, and thus such related image frames may need to be temporarily stored; according to the present invention, when the video decoder 225 is decoding video data, it may cooperate with the memory module 221 for such operation.

The video decoder 225 or the graphic data decoder 227 thus generates an image signal (such as RGB signal) to be displayed on the display device 250, and the audio decoder 226 generates an audio signal to be broadcasted by the audio output device 230.

Next, the processor 222 may cooperate with the image processing module 228 for processing the image signal generated by the video decoder 225 or the graphic data decoder 227. Similarly, according to the present invention, the image processing module 228 does not necessarily have to be a hardware circuit, but instead may be a firmware executable by the processor 222, to perform image processing operation in cooperation with the memory module 221.

Also similarly, the image signals may need to be temporarily stored; in this embodiment, the processor 222 (or the image processing module 228) may store such signals by means of the memory module 221.

Last, the LCD controller 260 displays the processed image signals on a display device 250 of the mobile phone 200, and the audio signals generated by the audio decoder 226 may be transmitted to an audio output device 230 though an audio output interface (not shown), to be broadcasted.

It may be readily seen from the above disclosure that the processor 222 and the memory module 221 are shared for error correction, the following image processing operation, and other operations. Thus, the present invention saves cost, reduces integrated circuit size, and improves the efficiency.

There are other benefits by such an integration architecture. In prior art, based on cost concern, the demodulation chip 110 can not be equipped with a high capacity DRAM or SRAM. However, in the present invention, there is a memory module 221 for the mobile phone 200, and this memory module 221 has a capacity and performance (bandwidth) much higher than the dedicated memory 130 in the conventional demodulation chip 110. Hence, when the mobile phone 200 is required to pick up a particular program from television signals or to perform error correction, it only occupies a portion of the bandwidth and capacity of the memory module 221; it does not affect the performance of the other decoding operations. On the other hand, when the mobile phone 200 is not required to perform decoding operation or related image processing operation, most of the bandwidth of the memory module 221 may be used for demodulation operation. Thus, the overall performance of the mobile phone 200 is improved.

In the abovementioned arrangement, the mobile phone 200 employs a memory module 221 of high capacity and high bandwidth (the memory module 221 may preferably include an SRAM 231 and a DRAM 232, to be described later). Since the memory module 221 are shared by many devices, it is important to use the memory module 221 efficiently. In the following disclosure, the present invention proposes an error correction method which efficiently uses the SRAM 231 and the DRAM 232 to improve the performance of error correction.

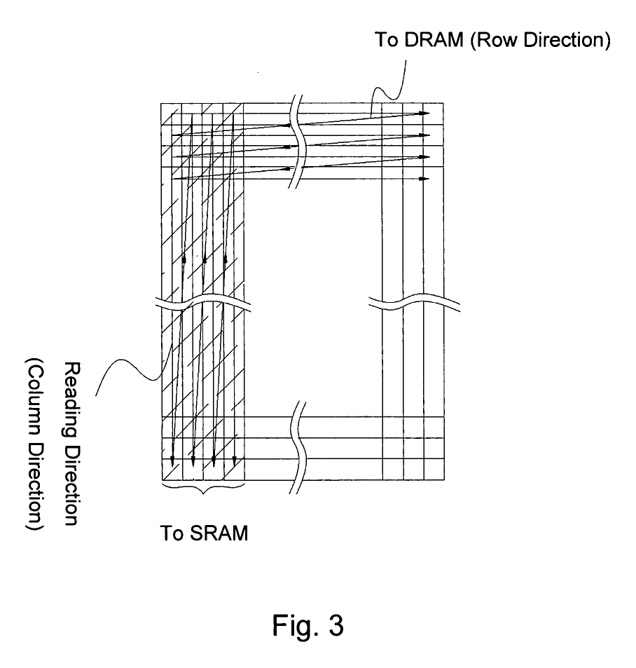

FIG. 3 shows an embodiment of an error correction operation according to the present invention. As mentioned above, in prior art, the data to be corrected are continuously stored in continuous addresses in the DRAM along one dimension, but during the following error correction decoding (such as Reed-Solomon decoding), data are read along the other dimension. However, in prior art, if an DRAM is accessed by column (the other dimension), the DRAM has to switch rows multiple times for each error correction code. This will consume huge bandwidth (clocks) of the DRAM.

In the embodiment according to the present invention, the processor 222 (or the error correction module 224) may use the SRAM 231 and the DRAM 232 in the memory module 221 for a more efficient error correction, as explained hereinafter.

First, the processor 222 (or the error correction module 224) continuously stores the data to be corrected (which may be the demodulated data, for example) in continuous addresses in the DRAM 232 along one dimension (by rows, for example), until a complete error correction block (ECC block) is stored. Then, error correction decoding is taken (such as Reed Solomon decoding).

It should be noted that during error correction, the data reading operation according to the present invention is different from that in the prior art. In this embodiment, when the processor 222 (or the error correction module 224) has to perform decoding along the other dimension (the column direction), the processor 222 (or the error correction module 224) does not just read data one by one along the other dimension (the column direction), but reads multiple data of different columns (i.e., several data at the same row) at one time. The read-out data are stored in the SRAM 231 so that when error correction operation requires an error correction code, it may access the SRAM 231 to retrieve such data.

In other words, during error correction in this embodiment, the SRAM 231 operates as a data reading buffer for the DRAM 232; because SRAM 231 is capable of providing continuous access of data, unlike the DRAM 232 which consumes huge bandwidth for switching rows, the overall efficiency may be improved by such arrangement.

As an example, as shown in FIG. 3, first, the data to be corrected are continuously stored in continuous addresses in the DRAM 232 of the memory module 221 along horizontal direction (by rows). It should be noted that, since the storing operation is continuous done by rows, no frequent switching is required. However, when data are to be read along the column direction, since data of one column correspond to multiple row addresses of the DRAM 232, the DRAM 232 has to frequently switch rows.

In this embodiment, when the processor 222 (or the error correction module 224) reads out data of one column, it concurrently reads out multiple data at the same row. As shown in FIG. 3, when reading the first data, i.e., the most upper-left data in the block, the processor 222 (or the error correction module 224) concurrently reads out multiple “neighborhood” data of multiple columns (i.e., data at the same row as that of the first data, but different columns), and stores in the SRAM 231.

Since such neighborhood data belong to the same row as that of the first data, they may be continuously read out from the DRAM 232 in one action without row switching; they are stored in the SRAM 231. Next, the processor 222 (or the error correction module 224) performs a similar operation on the second data (i.e., the data at the second row, first column) to concurrently read out neighborhood data at the second row in the shaded area, and store them in the SRAM 231. the steps are repeated until the last data is read out and stored in the SRAM 231, so that the SRAM 231 has been stored multiple columns of data (the shaded area of the block).

In the following error correction operation, the processor 222 (or the error correction module 224) only has to access the SRAM 231 for a column of data; after it has finished processing the first column, it may access the SRAM 231 for the second column, without accessing the DRAM 232. Thus, this saves the row switching time of the DRAM 232, and also improves the performance of the error correction.

It should be noted that according to the present invention, there is no limitation to the number of data on the same row that may be read out concurrently, that is, there is no limitation to the width of the shaded area. Theoretically, the larger the number is, the better the performance of the whole system will be. Practically, it depends on the available capacity of the SRAM 231. If the available capacity is large enough, even the whole error correction block may be stored in the SRAM 231, for the optimum efficiency. All such variations should belong to the scope of the present invention.

In the foregoing disclosure, the SRAM 231 is described as a reading buffer of the DRAM 232; however, it may be used as the writing buffer of the DRAM 232 as well.

For example, in writing data, the data may be written into the SRAM 231 by columns; after multiple columns have been filled, the data of the same row my be stored into the DRAM 232 at the same time. This arrangement improves the performance of writing the memory module 221. Such and other similar variations should also belong to the scope of the present invention.

It should also be noted that, the foregoing embodiment is based on the structure of a typical mobile phone, so there is an SRAM and a DRAM. However, the spirit of the present invention is not limited to that there must be one SRAM and one DRAM; the point is to provide a buffer memory, whose row switching speed is preferably not less than the main memory.

In addition, in the foregoing embodiment, the same processor 222 is used for both error correction and image processing. This is a benefit of but not a limitation to the present invention; depending on different requirements, there may be provided dedicated processors for different operations in cooperation with the memory module 221. Such and other similar variations should also belong to the scope of the present invention.

Further, in the foregoing embodiments, the tuner 211 is located externally to the integrated chip 220. However, such arrangement is only one possible structure according to the present invention. As long as the tuner 211 may provide its function, it may be integrated into the integrated chip 220 as well, for further reducing the overall cost. Such and other similar variations should also belong to the scope of the present invention.

It should also be noted that the mobile phone 200 is shown as an illustrative embodiment rather than limitation; the present application may be applied to any portable electronic device which processes multi-media information, such as mobile television, PDA, etc. Such and other similar variations should also belong to the scope of the present invention.

Moreover, the OFDM demodulator 223 is shown as an illustrative embodiment rather than limitation; the demodulator 223 may be any other demodulator suitable for demodulation based on the properties of the transmitted signals. The present application may also be applied to wireless applications. For example, by replacing the OFDM demodulator 223 by a demodulator (or packet decoder) in compliance with a wireless transmission protocol (such as 802.11b or g), the mobile phone 200 may support wireless network data transmission. Such and other similar variations should also belong to the scope of the present invention.

In comparison with prior art, many devices of the mobile phone according to the present invention are integrated in one integrated chip; thus these devices may share one memory module or even one processor, which not only saves cost but also reduces integrated circuit area. Moreover, the capacity and bandwidth of the memory module according to the present invention is better than that of the dedicated memory built in the conventional demodulation module chip, many operations are more efficient. In addition, the efficiency of the error correction method according to the present invention is optimized.

The features, characteristics and effects of the present invention have been described with reference to its preferred embodiments, which are illustrative of the invention rather than limiting of the invention. Various other substitutions and modifications will occur to those skilled in the art, without departing from the spirit of the present invention. Therefore, all such substitutions and modifications are intended to be embraced within the scope of the invention as defined in the appended claims.

What is claimed is:

1. An portable electronic device, comprising:
an integrated chip, including:
a memory module;
an ADC (analog-to-digital converter) for converting an analog input signal to a digital input signal;
a demodulator coupled to said memory module for demodulating said digital input signal to generate a demodulated signal, and storing said demodulated signal in said memory module;
an error correction module coupled to said memory module for performing error correction on said demodulated signal in said memory module to generate a multi-media signal;
a video decoder coupled to said memory module for receiving said multi-media signal and, in cooperation with said memory module, performing a video decoding operation on said multi-media signal to generate an image signal;
an audio decoder for receiving said multi-media signal and, in cooperation with said memory module, performing an audio decoding operation on said multi-media signal to generate an audio signal;
a graphic data decoder coupled to said memory module for receiving said multi-media signal and, in cooperation with said memory module, performing a graphic data decoding operation on said multi-media signal to generate a graphic data; and
an image processing module coupled to said memory module, and in cooperation with said memory module, for processing said decoded graphic data or image signal to generate a display signal; and
an output module coupled to said integrated chip for generating said display signal or said audio signal.

2. The portable electronic device according to claim 1, further comprising a tuner for receiving an external signal and generating said analog input signal from said external signal.

3. The portable electronic device according to claim 2, wherein said external signal includes a radio frequency signal.

4. The portable electronic device according to claim 1, wherein said integrated chip further comprises a tuner for receiving an external signal and generating said analog input signal from said external signal.

5. The portable electronic device according to claim 4, wherein said external signal includes a radio frequency signal.

6. The portable electronic device according to claim 1, wherein said demodulator is an OFDM (orthogonal frequency-division multiplexing) demodulator performing OFDM demodulation.

7. The portable electronic device according to claim 1, wherein said error correction module is a firmware executed by a processor.

8. The portable electronic device according to claim 7, wherein said image processing module is another firmware executed by said rocessor.

9. The portable electronic device according to claim 1, wherein said video decoder includes an MPEG decoder, and said video decoding operation is an MPEG decoding operation.

10. The portable electronic device according to claim 1, wherein said video decoder includes an H264 decoder, and said video decoding operation is an H264 decoding operation.

11. The portable electronic device according to claim 1, wherein said graphic data decoder includes a JPEG decoder, and said graphic data decoding operation is a JPEG decoding operation.

12. The portable electronic device according to claim 1, wherein said output module includes a display screen for displaying said display signal.

13. The portable electronic device according to claim 1, wherein said memory module includes a first memory module and a second memory module.

14. The portable electronic device according to claim 13, wherein said first memory module operates as a reading or writing buffer for said second memory module.

15. The portable electronic device according to claim 13, wherein said first memory module has a row accessing speed not less than that of said second memory module.

16. The portable electronic device according to claim 13, wherein said first memory module is a static random access memory, and said second memory module is a dynamic random access memory.

17. The portable electronic device according to claim 1, which is one selected from the group consisting of: mobile phone, mobile television, and personal digital assistant.
